(19) United States
(12) Patent Application Publication
(10) Pub. No.: US 2020/0307297 A1
(43) Pub. Date: Oct. 1, 2020

(54) BOOK MANUFACTURED FOR STORING AND DISPENSING MEDICATIONS, MEDICAL DEVICES, HEALTH-CARE DEVICES AND DENTAL DEVICES

(71) Applicant: Judith F. Joseph, New York, NY (US)

(72) Inventor: Judith F. Joseph, New York, NY (US)

(21) Appl. No.: 16/371,916

(22) Filed: Apr. 1, 2019

(51) Int. Cl. B42D 1/00; A61J 7/00; B42D 3/12

(52) U.S. Cl. CPC B42D 1/00; A63H 33/38; B42D 3/12; A61J 7/0076

(57) ABSTRACT

A children's book is provided having a recess formed on one or more leaves of the book wherein a container for storage of health-related articles can be disposed. The container can engage, in a fixed or replaceable manner, the back cover of the book. The container can have a cavity for storing a pill or pills, a syringe, a toothbrush, a thermometer, or added medical-related, health-related, dental-related devices or other personal care items

Successfully administering medication to a child creates numerous difficulties for the concerned parent or caregiver. Generally speaking, children do not look forward to taking medication. Where oral administration of a cough or cold medication is indicated, the child may object to swallowing a pill or ingesting a chewable one, complaining about difficulty in swallowing the contents, taste, texture or other circumstances. The same is true of an oral liquid medication such as an antibiotic administered by a syringe or liquid holder. The child may be in an anxious state, possibly because he or she is being asked to take the medication, has a fever and is irritable, or for these and/or other reasons prior to its administration, and proffering the medication may amount to the last proverbial straw. A child with special needs or sensitivities may compound difficulties.

What can be an emotionally fraught conflict between child and parent can also rise to a significant health issue with potentially substantially consequences if the child refuses to take a medication such as antibiotic. The child can push it away, possibly spilling precious prescribed medication such as an antibiotic, spit it out, or otherwise engage in noncompliance, such as simply by refusing to open his or her mouth.

The scenario at bedtime or before nap can be particularly difficult where after a long day a fatigued parent is trying to manage the child, especially a sick one. Although books may be read at bedtime to soothe the child and mark the end of the day, this bedtime ritual may be interrupted by the need to administer medication, leading to an all-too-familiar circumstance of a frustrated and tired parent and a frustrated and newly energized child.

It will be readily appreciated that the individual reading the book can be a parent of the child, be a caregiver for the child such as a relative or sitter, be a health-care provider, or another individual. For purposes of this document use of “parent” is meant to encompass all of the above. Indeed certain children can be substantially more anxious cared for by an individual who is not the parent, and thus the innovation herein can be of particular benefit.

### BRIEF DESCRIPTION OF DRAWINGS

FIG. 1 is a perspective view of a children's book in embodiments.

FIG. 2 is a perspective view of a children's book in embodiments, with a recess visible on the front cover.

FIG. 3 is an enlarged view showing leaves of a children's book in embodiments wherein the book is closed.

FIG. 4 is an enlarged view showing leaves of a children's book in embodiments wherein the book is in a slightly open state.

FIG. 5 is a perspective view of a children's book in embodiments showing a syringe container that is in a closed position.

FIG. 6 is a perspective view of a children's book in embodiments showing a syringe container that is in an open position.

FIG. 7 is an enlarged view of an inside back cover of a children's book in embodiments with a syringe container in an open position.

### DETAILED DESCRIPTION OF THE INVENTION

Embodiments herein describe a manufacture for storing medications for children.

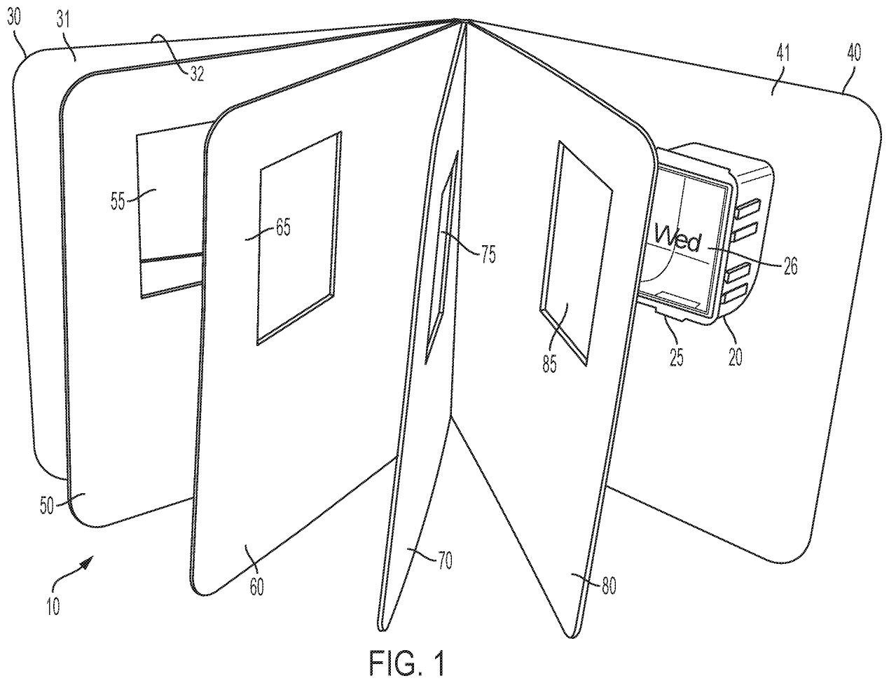

FIG. 1 is a perspective view of a children's book 10. Children's book 10 comprises a front cover 30 and back cover 40. Shown herein are inside portions 31, 41 of front cover 30 and back cover 40 respectively. Disposed on inside back cover 41 is a container 20 for a health-related article 20. In embodiments, disposed in engagement with inside back cover 41 can be a container 20 for a health-related article that can comprise a pill container, a syringe container, a toothbrush container, a thermometer container, and any combination of the foregoing. It will be appreciated that added health-related article(s) can be disposed therein, such as, to the extent relevant, a pill or pills, syringe, toothbrush, or thermometer, or combination thereof. More generally, the items stored can be health-related devices, medical devices, dental devices, or related to the above.

In various embodiments, securing the container 20 for a health-related article to inside back cover 41 can be accomplished by permanent or replaceable mechanisms. Container 20 can be a sealable container such as a pill container. The pill container can be permanently affixed to inside back cover 40. Such affixation can be done by gluing or other mechanisms. In embodiments, the affixation can extend through the inside back cover 41 to the outside back cover (not shown).

Further, container 20 can be replaceably engageable. For example, given the very same copy of book 10, a pill container, syringe container, toothbrush container, or thermometer container can be switched out depending on the desires of the parent or child. A fastening mechanism (not shown), such as a clip, latch or other mechanism, can secure container 20 to book 10. The mechanism for pairing with one or more containers can be affixed to back inside cover 41, or extend outwards to the outside back cover (not shown). The containers themselves can have a mechanism that replaceably pairs with the mechanism on back inside cover 41 or extends therethrough. In this manner, container 20 can be switched out easily. For example, the parent can insert a pill container on a Monday, a syringe container on a Tuesday, etc., as desired or needed. Mechanisms for replaceably affixing a small container to a substantially rigid backing are readily ascertainable by those of skill in the art.

Returning to FIG. 1, it can be seen that there are multiple leaves 50, 60, 70, 80. Each leaf (sheet) can comprise a front page and a rear page. Leaf 50 is bounded by (toward the front of book 10) an exterior front cover 30 and an interior second leaf 60, and added leaves are of course possible. Front cover 30 and back cover 40 can be considered leaves.

In embodiments, leaf 50 has a recess 55. When book 10 is closed, container 20 can be disposed through recess 55. More generally, it can be appreciated that pill container 20 can be disposed within recesses 65, 75, and 85 of additional leaves 60, 70, 80. In this manner, pill container 20 can be visible from the front cover 30 of the book. As the book is read to the child by the parent or caregiver from the first pages to the last ones, a leaf will be turned, and pill container 20 can remain visible through the recessed portion. In other embodiments, the front cover is integral without a recess disposed therein. In this embodiment, container 20 cannot be seen when book 10 is closed. Rather, container 20 can emerge as visible upon opening the book and viewing the front page of first leaf 50. Or, container 20 can emerge at second leaf 60, and so on. There may be a resealable or sealable member (not shown) on any give leaf (and front cover 30) that can cover container 20 from view by the child, and the parent can remove the resealable or sealable member to show container 20. The member may be non-resealable.

Children's books may be prepared of relative sturdy materials. These materials may be paper-based, polymer-based, a combination thereof or another substance(s). In this respect, leaves may have a sturdier quality with less “give” for a specified leaf than with an adult's book. Some children's books may be considered “board books” accordingly. By reducing forces on container 20 from opening or closing the book, or turning leaves, there can be less stress on container 20. Further, back cover 40 can be made of a material sturdier than that of inside leaves 50, 60, 70 and 80. In this manner affixation can be made between container 20 and inside back cover 41 or back cover 40 in a more robust manner. In addition, thickness of back cover 40 can be greater than that of leaves 50, 60, 70 and 80. It will be appreciated that back cover 30 can be both sturdier and thicker than one or more leaves, again as it may anchor container 20, and form a basis for replaceably or permanently engaging container 20 in a long-lasting manner to stand up to repeated use not to mention curious small fingers.

It will be understood that there may well be multiple leaves in book 10. Some or many leaves may be of uniform thickness and/or sturdiness; alternatively, there may be groups of leaves of varying thickness or sturdiness. Leaves may vary individually in thickness in multiple ways in accord with embodiments.

Container 20 may be made of a polymer or other material or materials suitable for the health-care article contained therein. Dimensions of container 20, for pills, can be 2.75 cm wide×4.0 cm long×2.0 cm deep. Dimensions of container 20 for a syringe or syrup holder can be 20.0 cm long by 4.0 cm wide by 2.5 cm deep. In embodiments, container 20 must be long enough to hold a syringe when it is full, or have at least one cavity through which the syringe can be disposed. It will be evident to one of skill in the art that these dimensions can vary. In non-limiting embodiments, then, it will be readily apparent that container 20 can represent multiple shapes of multiple dimensions in which a health-related article can be stored. Container 20 can contain subcontainers for storing two or more health-related articles.

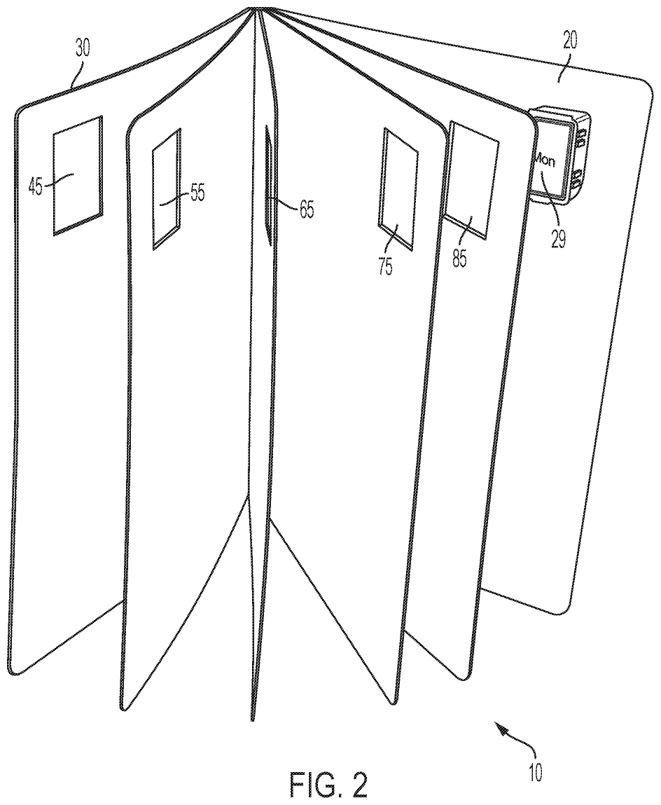

Container 20 can have a cover 25 that flips open to provide access to medication. There may be markings 26 on cover 25. The marking shown in FIG. 1 is “Wed”, meaning that the pill is meant to be taken on Wed. Other markings can be provided. As can be seen in FIG. 2, for example, the marking 29 on container 25 is “Mon”, indicating Monday. Of course, any day of the week can be used. Another legend can be used indicating a different day of the week, week itself, child's name, or other identifier associated with the health-related article.

Additionally, FIG. 2 shows plainly that front cover 30 can have a recess 45. Recess 45 can, in cooperation with recesses 55, 65, 75, 85 in added interior leaves, bound container 20. Additional leaves with additional recesses therein can be constructed.

A toothbrush can be disposed in container 20. Again, container 20 can be adapted to contain the toothbrush residing therein. As well, a thermometer can be contained in container 20, with suitable adaptations to container 20 to accommodate the thermometer. To be sure, there may be multiple containers, each having the proper dimensions for holding, as appropriate, pills, a syringe, a toothbrush, and a thermometer.

In operation, book 10 can be held by a parent reading to a child. The parent or child can open container 20 to reveal the health-related article therein, be it a pill, syringe, toothbrush, thermometer or other item. Book 10 can be constructed so that container 20 can be opened when book 10 is closed, or when the last leaf is reached, or in another manner.

It will be appreciated that in embodiments the contents of the book, such as the story and illustrations, may provide a narrative that facilitates the chances that the child will take the medication. A character or characters in the book can have the same condition as the child in the target pediatric population, have other identifiable characteristics in common with the child, and so on. The characters can manifest anxiety about taking medication, brushing teeth, having temperature taken, and so forth. However, the character can be shown to take the medication, brush teeth, or have temperature taken. In other words, the health-related article can be woven into the narrative of the book. The narrative can be comprised of textual elements, graphical elements such as pictorial features, and/or sensory-stimulating elements that can be found in a children's book, such as those that generate a sound, certain fabrics or textures, and more.

It must be borne in mind that the content of the book does not need to revolve around health or taking medications. Rather, the manufacture described herein can increase health-care compliance among the pediatric population by providing a secure, convenient, safe location for storing a health-related item for a child. Further, it provides the opportunity for parent and child to share an experience, which can relax the child and make him or her more responsive to receiving the medication that is or will soon become visible as the book is read. This “normalizes” the process, offers a physically immediate and convenient mechanism for the parent to administer the needed medication to the child, and ultimately increases medication compliance.

In embodiments, the affixation can be accomplished by an engagement mechanism in cooperation with inside front cover 31, the mechanism for which can extend through or beyond the outside back cover. The affixation can be accomplished by securing container 20 to a leaf or leaves in the interior of book 10. Additional methods of engaging container 20 with inside back cover 41, or inside front cover 31, or a leaf thereon are available.

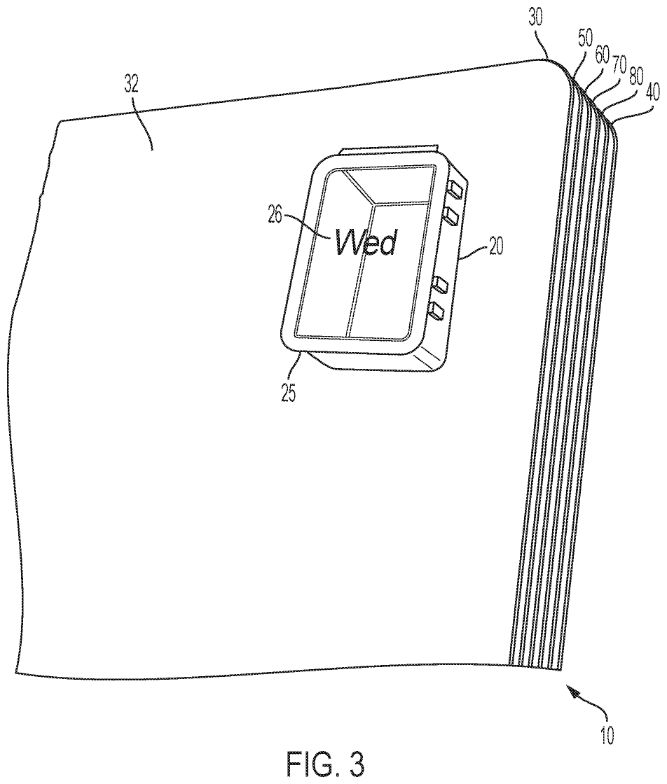

FIG. 3 is an enlarged view showing an embodiment wherein book 10 is in a closed position. Container 20 can be seen extending through recesses formed by the appropriate leaves in question. When parent and child view the front 32 of front cover 30, container 20 is readily visible, although in fact container 20 can be affixed to inside back cover 41.

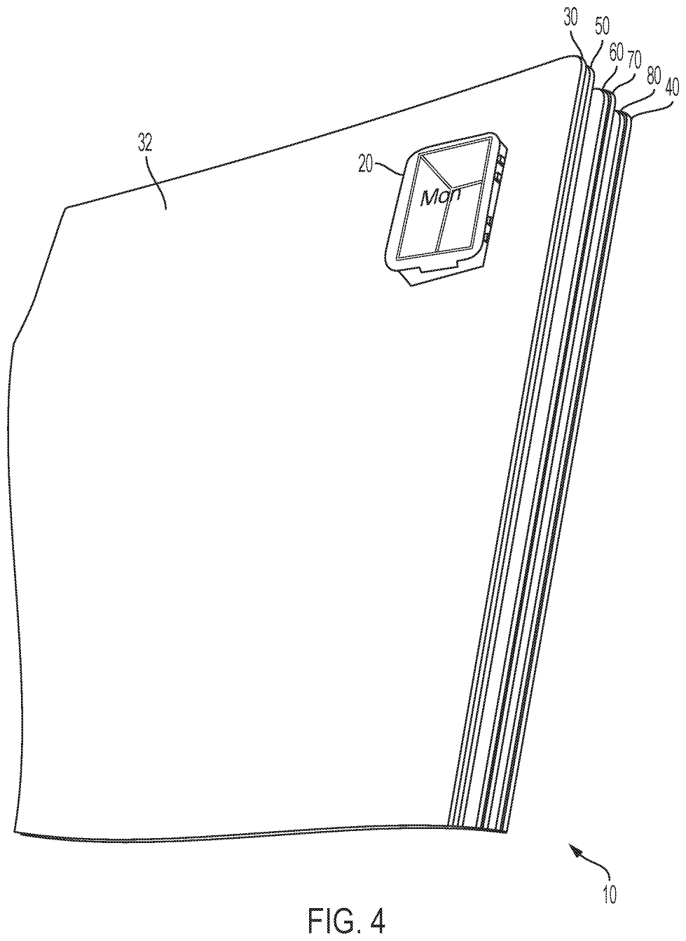

FIG. 4 is an enlarged view of book 10 in a slightly opened form. Container 20 can be seen extending through all leaves 30, 50, 60, 80, 40, and is visible when viewing the front page 32 of front cover 30.

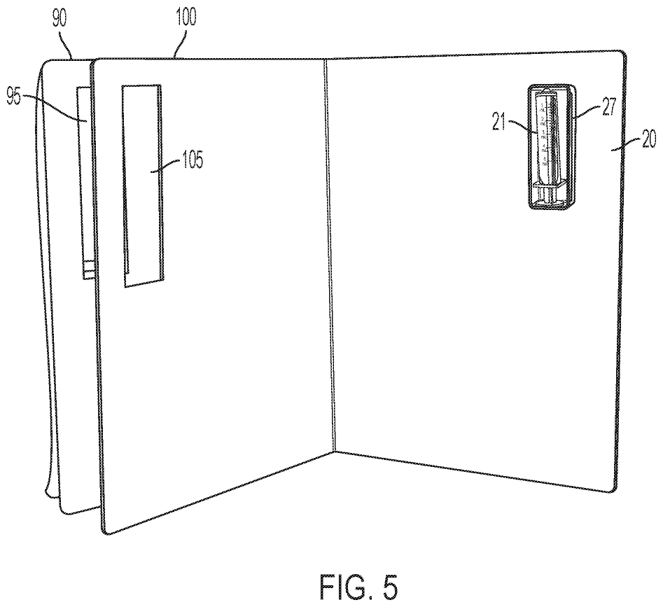

FIG. 5 is a view of a container 20 that holds a syringe 21. In embodiments syringe 21 can be a vessel that contains medication for dispensing orally to a child. Such medications can be antibiotics, anti-inflammatories, antipyretics, and more. In other embodiments it may be a syringe for injection of a substance including but not limited to insulin. The medication can be located in the syringe when it is placed in book 10, or can be empty and filled after removal from book 10. For this embodiment and others, container 20 can be constructed of multiple containers. Further, it can be seen that leaf 90 has a recess 95 through which container 20 can be disposed when the book is closed. Container 20 is shown here, in embodiments, to have a substantially transparent openable flap. Additional leaves can be present such as leaf 100, each formed with a recess such as recess 105.

It will be appreciated that the recesses that bound container 20—be it a container for pills, syringe, toothbrush, thermometer, or other item—can assume a shape based on the that of container 20. This is to enable container 20 to extend cleanly through the recesses, and also to enable the book to undergo less wear and tear.

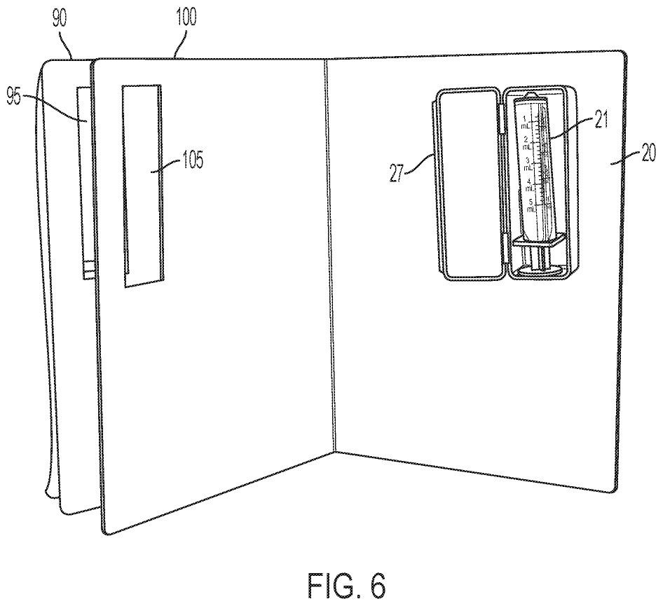

FIG. 6 shows an embodiment in which container 20 is in an open position. Flap 27 is open, enabling syringe 21 to be inserted and removed easily.

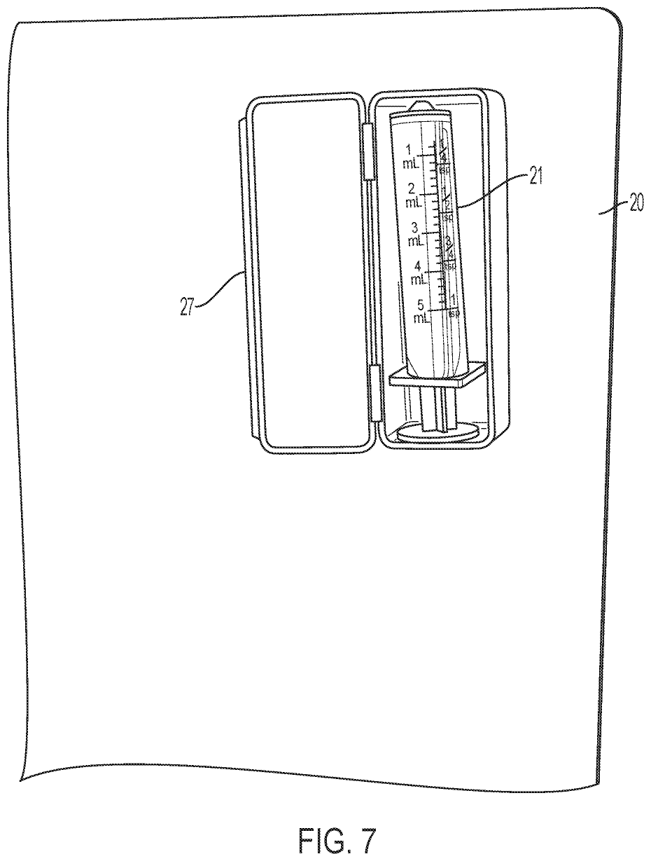

FIG. 7 is an enlarged view of container 20, showing flap 27 in an open position. Syringe 21 is disposed in the cavity of container 20.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

I claim:

1. A children's book for storing a container for a health-related device, the children's book comprising:
a front cover;
a first leaf having a recess formed thereon; and
a back cover on which is mountable a container for the health-related device, wherein the recess formed by the first leaf is structured to permit the container for the health-related device to extend therethrough when the children's book is in a closed position.

2. The children's book of claim 1, wherein the health-related device is a pill container.

3. The children's book of claim 1, wherein the health-related device is a syringe.

4. The children's book of claim 1, wherein the health-related device is a toothbrush.

5. The children's book of claim 1, wherein the health-related device is a thermometer.

6. The children's book of claim 1, wherein the front cover has a recess formed thereon through which the container for the health-related device can extend when the book is closed.

7. The children's book of claim 1, wherein the front cover is integrally formed and lacks a recess such that the container is not visible when the book is closed.

8. The children's book of claim 1, wherein the back cover fixedly engages the container for the health-related article

9. The children's book of claim 8, wherein the back cover is in operative communication with a mechanism that replaceably engages the container for the health-related article.

10. The children's book of claim 1, wherein the shape of the recesses formed are substantially similar to the shape of the container.

11. A method of manufacturing a children's book having a back cover that engages a health-related article, the method comprising:
Providing a front cover of the children's book;
Providing at least one leaf of the children's book; and
Structuring the back cover to engage a container for the health-related article, wherein the at least one leaf has a recess formed thereon through which the health-related article can extend when the book is closed.

12. The method of claim 11, wherein the front cover has a recess formed thereon through which the container for the health-related article can extend.

13. The method of claim 11, wherein the back cover fixedly engages the container for the health-related article.

14. The children's book of claim 11, wherein the back cover is in operative communication with a mechanism that replaceably engages the container for the health-related article.

15. The children's book of claim 11, wherein the shape of the recesses formed are substantially similar to the shape of the container.

16. A children's book having a container for health-related device, the children's book comprising:
A front cover;
A back cover on which the health-related device is mounted;
A plurality of leaves, wherein at least one of leaf has a recess formed thereon through which the container for the health-related device can be disposed when the book is in a substantially closed position, and
Textual or pictorial features the subject matter of which are health-related.

17. The children's book of claim 16, wherein the textual or pictorial features create a narrative that encourage a child to engage in a health-related activity.

18. The children's book of claim 16, wherein the health-related activity is one or more of taking a pill, ingesting the contents of a syringe, brushing the child's teeth, or taking the child's temperature.
